(19) United States
(12) Patent Application Publication
(10) Pub. No.: US 2011/0242064 A1
(43) Pub. Date: Oct. 6, 2011

(54) OPERATION UNIT

(75) Inventors: Takatsugu ONO, Kobe-shi (JP); Kazuyoshi KASAI, Kobe-shi (JP); Takashi NIIYAMA, Isesaki-shi (JP); Satoshi SATO, Fujisawa-shi (JP); Yoshiyasu MINAMINO, Kobe-shi (JP)

(73) Assignees: FUJITSU TEN LIMITED, Kobe-shi (JP); HOSIDEN CORPORATION, Yao-shi (JP)

(21) Appl. No.: 13/072,032

(22) Filed: Mar. 25, 2011

(30) Foreign Application Priority Data
Mar. 31, 2010 (JP) 2010-083923

(51) Int. Cl. G09G 5/00

(52) U.S. Cl. 345/184

(57) ABSTRACT

The operation unit includes a shaft that receives by its one end a pressing force applied through a pressing operation by a finger/thumb, a rotating body that rotates about the shaft according to an operation by the finger/thumb within a movable range of the finger/thumb, a first sensor that detects a pressing force applied to the shaft in an axial direction of the shaft, a second sensor that detects a pressing force applied to the shaft in a direction other than the axial direction of the shaft, and a third sensor that detects a rotating state of the rotating body.

### CROSS-REFERENCE TO RELATED APPLICATIONS

This application is based upon and claims the benefit of priority of the prior Japanese Patent Application No. 2010-083923, filed on Mar. 31, 2010 the entire contents of which are incorporated herein by reference.

### BACKGROUND OF THE INVENTION

1. Field of the Invention

The present invention relates to an operation unit, and more particularly to an operation unit which can improve the operability of an electronic device by allowing a wide variety of control operations to be executed by the electronic device.

2. Description of the Related Art

Conventionally, operation units for electronic devices have been known. The operation unit receives various types of operations and causes the electronic device to execute a control operation corresponding to the type of received operation. For example, Japanese Patent Application Laid-open No. 2003-36131 (hereinafter, “First Document”) describes an operation unit. A user can manipulate this operation unit by one finger to make the zoom mechanism of an imaging device execute more than one type of control operations.

More specifically, the operation unit described in First Document causes the electric currents to flow to the zoom mechanism when an operation portion arranged at one end of a shaft is pressed down in an axial direction of the shaft, and drives the zoom mechanism when the operation portion is kept in a pressed state and moved such that the shaft tilts.

The operation unit described in First Document can realize two types of control operations via the operation by one finger, i.e., the conduction of the zoom mechanism and the driving of the zoom mechanism, and thus can improve the operability of the imaging device.

The operation unit today, however, is demanded to have even wider variety of functions to meet the increasingly multifunctional characteristic of the electronic devices. The operation unit as described in First Document which realizes merely two types of control operations through operation by one finger has a problem that it cannot improve the operability of electronic devices to a satisfactory level.

For example, an operation unit which controls the operations of a car navigation device needs to realize various types of control operations such as map scrolling, map zooming and menu selection. On the other hand, since in-vehicle devices such as the car navigation device are often operated by the driver during driving, it is desirable that an operation range, i.e., an area in which the user moves his/her finger for operation be as small as possible.

Thus, a big challenge is to realize an operation unit which can improve the operability of electronic devices by allowing the electronic devices to execute still wider variety of control operations through the operation by one finger.

### SUMMARY OF THE INVENTION

It is an object of the present invention to at least partially solve the problems in the conventional technology.

According to one aspect of the present invention, an operation unit includes a shaft that receives by its one end a pressing force applied through a pressing operation by a finger/thumb, a rotating body that rotates about the shaft according to an operation by the finger/thumb within a movable range of the finger/thumb, a first sensor that detects a pressing force applied to the shaft in an axial direction of the shaft, a second sensor that detects a pressing force applied to the shaft in a direction other than the axial direction of the shaft, and a third sensor that detects a rotating state of the rotating body.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIGS. 1A to 1E are diagrams illustrating an overview of an operation unit according to the present invention;

FIG. 2A is a diagram illustrating an example of an application of an operation unit according to an embodiment;

FIG. 2B is a plan view of an operation portion of the operation unit according to the embodiment, as viewed from a driver's viewpoint;

FIG. 2C is a sectional view of the operation portion along X-X of FIG. 2B;

FIG. 3 is a diagram illustrating an example of operation of each in-vehicle device realized through the operation of the operation unit according to the embodiment;

FIG. 4A is a sectional view of the operation unit according to the embodiment;

FIG. 4B is an enlarged partial sectional view of the section illustrated in FIG. 4A;

FIG. 5 is a block diagram illustrating a functional structure of the operation unit according to the embodiment;

FIGS. 6A to 6C are diagrams illustrating an example of operation of the operation unit according to the embodiment;

FIGS. 7A to 7C are diagrams illustrating an example of display corresponding to the operation of the operation unit according to the embodiment;

FIGS. 8A to 8C are diagrams illustrating modifications of a pressing operation unit and rotating operation unit of the operation unit according to the embodiment; and

FIG. 9 is a block diagram illustrating an operation unit connected to sensors.

### DETAILED DESCRIPTIONS

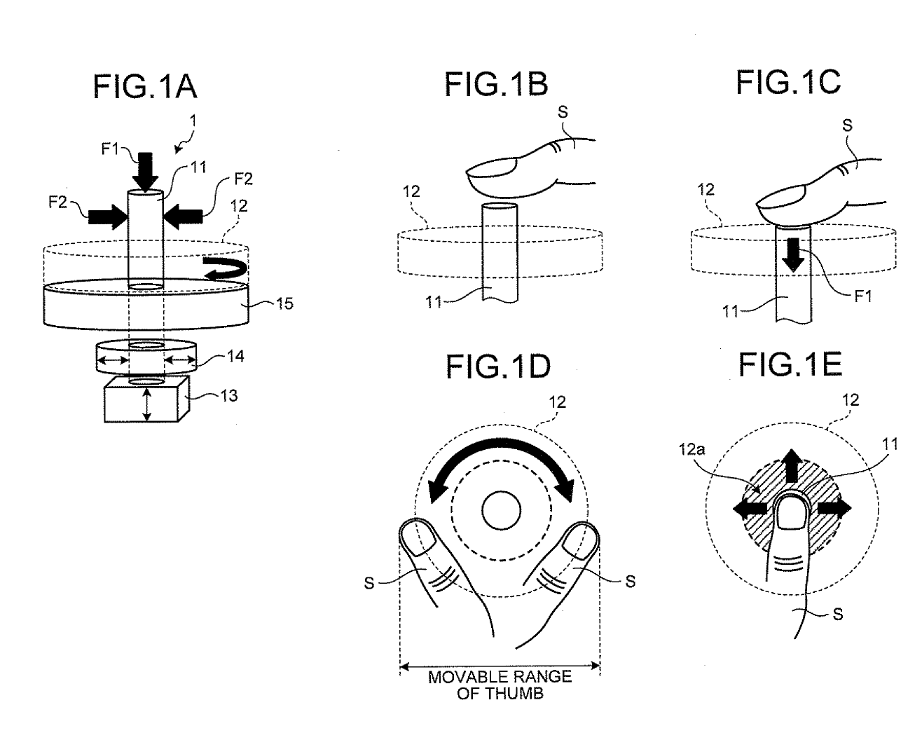

Exemplary embodiments of an operation unit according to the present invention will be described in detail below with reference to the accompanying drawings. Firstly, before starting the detailed description of the embodiment, an overview of the operation unit according to the present invention will be described with reference to FIGS. 1A to 1E. FIGS. 1A to 1E are diagrams illustrating the overview of an operation unit 1 according to the present invention.

FIGS. 1A to 1E schematically illustrate relevant constituent elements for describing the feature of the operation unit 1. It should be noted that the shape and the arrangement of each element of the operation unit 1 illustrated in FIGS. 1A to 1E do not limit the scope of the present invention.

An example of the operation unit 1 applied as an operation unit of an in-vehicle device will be described below. The operation unit 1 of the present invention, however, can be applied to the operation unit of any electronic device.

The operation unit 1 as illustrated in FIGS. 1A to 1E works favorably as the operation unit of the in-vehicle device. In particular, the operation unit 1, when arranged at a predetermined position of a steering wheel of a vehicle, allows a driver to perform operations only by one finger, i.e., a thumb S while keeping the hand on the steering wheel to cause the in-vehicle device to execute various types of control operations, while preventing an erroneous operation by the driver.

More specifically, as illustrated in FIGS. 1A to 1E, the operation unit 1 allows a user to perform three different types of operations only by using the thumb S, thus the operation unit 1 allows the driver to cause the in-vehicle device to execute at least three different types of control operations by manipulating the operation unit 1 only by the thumb S without taking his/her hand off the steering wheel.

Further, by suppressing the interference among three types of respective operations, the operation unit 1 prevents the in-vehicle device from executing a control operation other than a desirable one, even when the driver operates using the thumb S which is not suitable for delicate manipulation. Still further, the operation unit 1, by giving a driver a clear sense of accomplished operation, makes the driver recognize that the operation unit 1 is surely operated thereby preventing the erroneous operation by the driver.

Specifically, as illustrated in FIG. 1A, the operation unit 1 includes a shaft 11 which receives at its one end a pressing force applied by the thumb S, and a rotating body 12 which rotates about the shaft 11 when the user operates the operation unit 1 by the thumb S within the movable range of the thumb S. The shaft 11 is configured to be movable only in an axial direction. In addition, the rotating body 12 and the shaft 11 are configured as separate members so that the operation of one member is not linked to the operation of the other.

Further, the operation unit 1 includes a switch 13 which detects a pressing force F1 applied to the shaft 11 in the axial direction of the shaft 11 to detect the operation to the shaft 11 in the axial direction thereof, a vector sensor 14 which detects a pressing force F2 applied to the shaft 11 in a direction other than the axial direction of the shaft 11 to detect the operation to the shaft 11 in a direction other than the axial direction. In addition, the operation unit 1 includes a rotation sensor 15 which detects the rotating state of the rotating body 12.

The operation unit 1 can make a predetermined in-vehicle device execute three types of control operations by sending control signals respectively corresponding to the operations detected by the switch 13, the vector sensor 14, and the rotation sensor 15 to the in-vehicle device.

Further, because the rotating body 12 of the operation unit 1 rotates about the shaft 11 within the movable range of the thumb S, i.e., a range the thumb S can move while the driver grabs the steering wheel, the driver can operate both the shaft 11 and the rotating body 12 individually through the operation by the thumb S.

Further, as illustrated in FIGS. 1B and 1C, the shaft 11 of the operation unit 1 is configured to slide by a predetermined length in a direction of pressing force F1 when the thumb S applies the pressing force F1 in the axial direction of the shaft 11.

When being pressed in the axial direction, the shaft 11 slides. Because of this, the operation unit 1 can give the driver a clear feeling that the operation is accomplished (feeling of a click). Hence, the operation unit 1 can prevent the driver from repeatedly pressing the shaft 11 in the axial direction by mistake after the operation unit 1 properly receives the pressing operation of the shaft 11 in the axial direction.

As illustrated in FIG. 11), the rotating body 12 of the operation unit 1 is configured to rotate about the shaft 11 as a rotation axis when the driver puts his/her thumb S on the rotating body 12 while keeping his/her hand on the steering wheel and slides the thumb S within the movable range of the thumb S in a direction other than the axial direction of the shaft 11.

Thus, in the operation unit 1, while the driver operates the rotating body 12 by the thumb S, the thumb S moves as if to draw an arc along the rotational trajectory of the rotating body 12. Therefore, the operation unit 1 can prevent the driver from operating the shaft 11 by mistake while operating the rotating body 12 by the thumb S.

Further, it is possible to form a depressed portion in an operation surface of the rotating body 12 in a predetermined region around the center of rotation. For example, as illustrated in FIG. 1E, a depressed portion 12a may be formed in the operation unit 1 in the movable range of the thumb S, i.e., within an area where the driver can move the thumb S to push the shaft 11 in a direction other than the axial direction while keeping the hand on the steering wheel.

When the depressed portion 12a is formed in the operation surface of the rotating body 12, the operation unit 1 can prevent the driver from operating the rotating body 12 by touching the rotating body 12 by the thumb S by mistake while pushing the shaft 11 by the thumb S in a direction other than the axial direction.

The operation unit 1 may be configured with the shaft 11 having a different configuration at its end. With such configuration, the driver can more clearly sense that the operation has been done when the shaft 11 is pressed in a direction other than the axial direction. Such configuration of the shaft 11 will be described later in the description of another embodiment.

The operation unit 1 can receive three types of operation individually from the movement of the thumb S. In addition, in the operation unit 1, all three types of operations can be done by an operation within an operable range which is a range where the user can move his/her thumb S without moving his/her palm.

Hence, when the operation unit 1 is arranged at a position on the steering wheel grabbed by the driver, the driver can safely make the in-vehicle device execute various types of control operations even during driving only by the operation by the thumb S without taking his/her hand off from the steering wheel.

Further, the operation unit 1 is configured to give the driver a clear sense of operation while preventing the interference among three types of operations. In particular, the operation unit 1 is configured such that, when the shaft 11 is pressed in the axial direction, the shaft 11 slides in the direction of pressing force. Therefore, the operation unit 1 can give the driver a clear sense of pushing (feeling of a click).

Hence, even when the driver operates the operation unit 1 by the thumb S, which is not suitable for a delicate operation, while the vehicle is shaking, the driver can clearly sense that the operation has been accomplished.

In the following, an embodiment of the operation unit 1 described with reference to FIGS. 1A to 1E is described further in detail. In the following, an example where an operation unit 100 according to the embodiment is applied as the operation unit for the in-vehicle device is described. It should be noted, however, that the operation unit 100 according to the present invention may be applied to the operation unit of any electronic device.

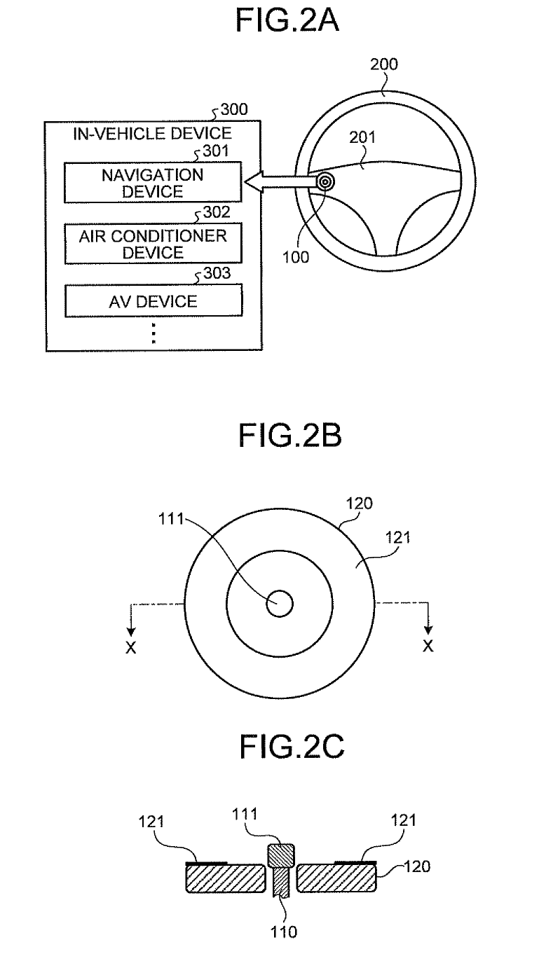

FIG. 2A is a diagram illustrating an example of application of the operation unit 100 according to the present embodiment, FIG. 2B is a plan view of an operation portion of the operation unit 100 according to the present embodiment viewed from a driver's viewpoint, and FIG. 2C is a sectional view of the operation portion along X-X of FIG. 2B.

As illustrated in FIG. 2A, the operation unit 100 is arranged at a predetermined position of a steering wheel 200 of a vehicle. Specifically, the operation unit 100 is arranged at the end of a spoke 201 of the steering wheel 200 at such a position where the driver puts his/her thumb on when grabbing the steering wheel 200 by the hand.

In the operation unit 100, operating portions are arranged such that the driver can perform every operation within an operable range (movable range of the thumb) where the driver can move his/her thumb while grabbing the steering wheel 200, i.e., while keeping his/her palm at a fixed position.

Further, the operation unit 100 receives more than one type of operation from the thumb of the driver, and transmits the control signal corresponding to the received operation to an in-vehicle device 300. Then, the in-vehicle device 300 executes a control operation corresponding to the control signal supplied as an input from the operation unit 100.

The in-vehicle device which operates by the operation of the operation unit 100 is, for example, a navigation device 301, an air conditioner device 302, and an audio video (AV) device 303, as illustrated in FIG. 2A. The operation unit 100 can operate any in-vehicle device when connected to an optional electronic device mounted on the vehicle such as a power window device, lighting device of the vehicle, and auto-cruise device, other than the in-vehicle device 300 illustrated in FIG. 2A.

The operation unit 100 includes a pressing operation unit 111 which is arranged at one end of a shaft 110 to receive a pressing operation by the thumb of the driver, and a rotating operation unit 120 which receives a rotation operation by the thumb of the driver. The shaft 110, the pressing operation unit 111 and the rotating operation unit 120 correspond respectively to the shaft 11, the operation portion arranged at one end of the shaft 11 and the rotating body 12 illustrated in FIG. 1A.

The pressing operation unit 111 is an operation portion which receives a pressing operation by the thumb in the axial direction of the shaft 110 (hereinafter simply referred to as “axial direction”) and a pressing operation by the thumb in a direction other than the axial direction. Hereinafter, the pressing operation in the axial direction is referred to as pushing operation, and the pressing operation in the direction other than the axial direction is referred to as tilting operation. Herein, the tilting operation is not the operation to tilt the shaft 110, but the operation to push the shaft 110 in a tilting direction of the shaft 110.

When the pressing operation unit 111 receives pushing operation, the operation unit 100 outputs a control signal indicating that the pushing operation is performed to the in-vehicle device 300. Further, when the pressing operation unit 111 receives a tilting operation, the operation unit 100 outputs a control signal corresponding to the pressing force at the time of tilting operation to the in-vehicle device 300.

Further, the rotating operation unit 120 is an operation portion which rotates around the shaft 110 as the rotation axis when receiving a rotating operation by the thumb. Reference character 121 shown in FIGS. 2B and 2C indicates an antislip member arranged on an operation surface of the rotating operation unit 120.

The rotating operation unit 120 is configured with a disk-shaped member as illustrated in FIGS. 2B and 2C. The diameter of the disk-shaped member which demarcates the operation range of the rotating operation unit 120 is set so that the operation range is a range where the adult can move the thumb while keeping the palm unmoved (i.e., movable range of the thumb). Thus, the driver can safely perform three types of operations, i.e., the tilting operation, pushing operation and rotating operation, on the operation unit 100 through the operation by the thumb S without taking the hand off from the steering wheel 200.

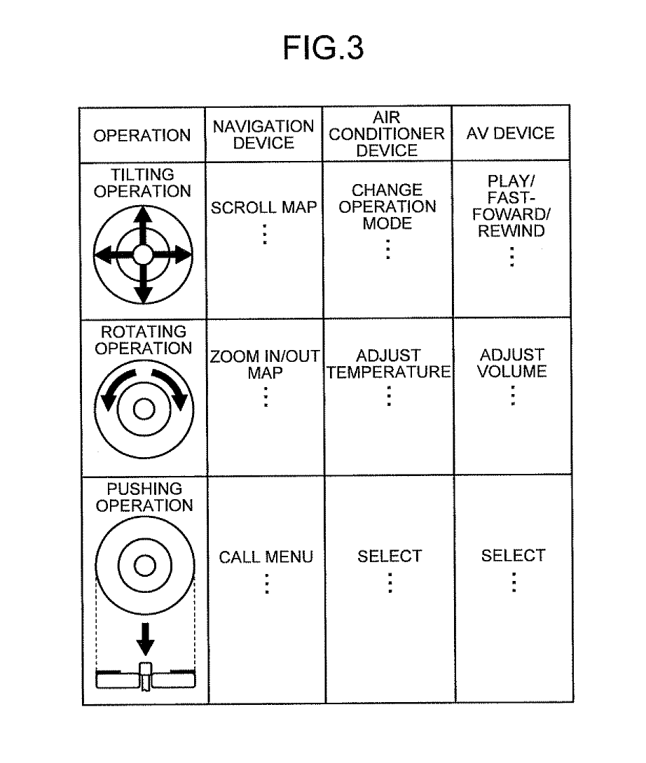

Further, the operation unit 100 can cause each of the in-vehicle devices 300 to execute at least three types of control operations by switching the operation target from one in-vehicle device 300 to another. An example of the operation of each of the in-vehicle devices 300 realized through the operation of the operation unit 100 is described below with reference to FIG. 3.

FIG. 3 is a diagram illustrating an example of an operation of each of the in-vehicle devices 300 realized through the operation of the operation unit 100 according to the present embodiment. As illustrated in FIG. 3, when switching the operation target to the navigation device 301, the operation unit 100 can scroll a map on the display via tilting operation, zoom the map on the display by rotating operation, and call the menu by pushing operation, for example.

Further, when the operation target is switched to the air conditioner device 302, the operation unit 100 can change the operation mode, adjust the temperature, and select the operation mode or the temperature, respectively via tilting operation, rotating operation, and pushing operation. Further, when the operation target is switched to the AV device 303, the operation unit 100 can play, fast-forward and rewind the contents, adjust the volume, and select the contents or the like, respectively via tilting operation, rotating operation and pushing operation.

As described above, when the operation unit 100 is connected to more than one type of in-vehicle devices 300 and the operation target is switched from one in-vehicle device 300 to another, the operation unit 100 can cause each of the in-vehicle devices 300 to execute various types of control operations.

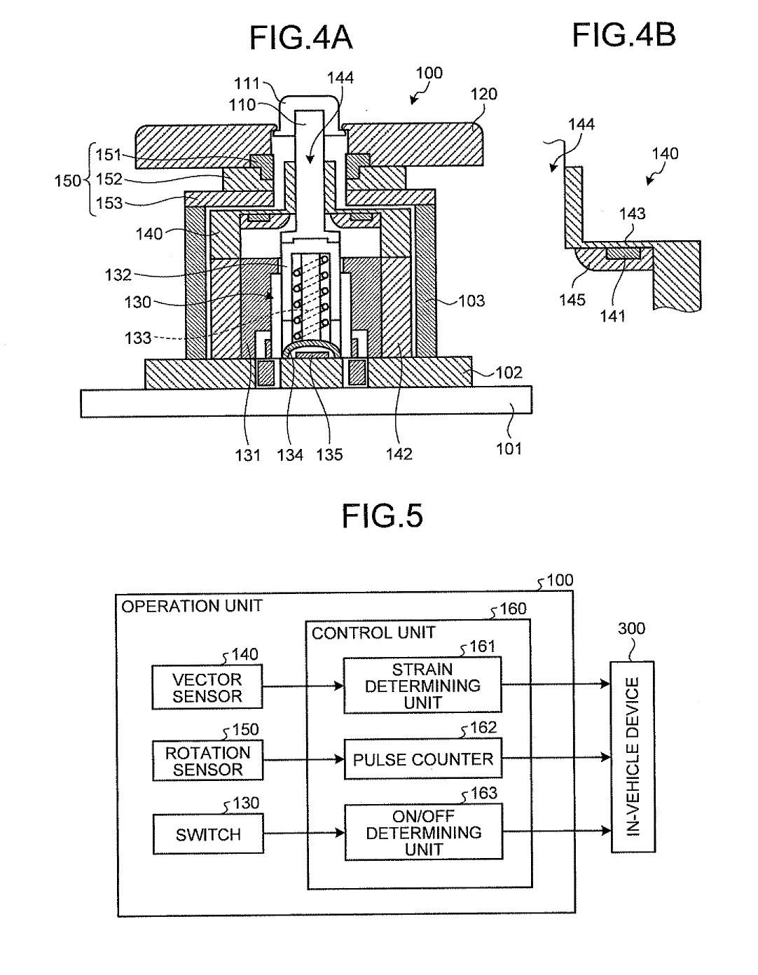

A mechanical configuration of the operation unit 100 according to the present embodiment will be described with reference to FIGS. 4A and 4B.

FIG. 4A is a sectional view of the operation unit 100 according to the present embodiment, and FIG. 4B is a partial, enlarged sectional view of a portion illustrated in FIG. 4A. FIG. 4A illustrates an overall section of the operation unit 100 along X-X of FIG. 2B. FIG. 43 illustrates an enlarged section of a portion of the operation unit 100 corresponding to a vector sensor 140 described later.

As illustrated in FIG. 4A, the operation unit 100 is attached by a bolt or the like (not shown) to a plate-shaped stay 101 arranged inside the spoke 201 of the steering wheel 200. In the following explanation, a side of the plate surface of the stay 101 where the operation unit 100 is arranged is referred to as an upper side with the up-down direction coinciding with a direction perpendicular to the plate surface.

The operation unit 100 includes a base plate 102 which is brought into contact with the stay 101 at the time of attachment, and a cylindrical frame 103 which stands on the base plate 102 and has upper and lower open ends. At the central position on the base plate 102 within the frame 103, a switch 130 is arranged. The switch 130 is turned into an ON state when the pressing operation unit 111 receives a pushing operation.

The operation of the switch 130 will be described later. The switch 130 corresponds to the switch 13 illustrated in FIG. 1A. In FIG. 4A, 131 indicates a spacer which fixes the switch 130 at the position, and 132 indicates a sliding body which slides up and down together with the shaft 110.

In FIG. 4A, 133 indicates a spring which exerts a force on the sliding body 132 upwards, and 134 indicates a movable contact which deforms into a depressed shape pressed by the lower end of the sliding body 132 when the sliding body 132 slides downwards, and 135 indicates a fixed contact which is brought into contact with the movable contact 134 when the movable contact 134 deforms into a depressed shape.

On the switch 130, the vector sensor 140 is arranged. The vector sensor 140 detects the magnitude and the direction of a pressing force applied to the pressing operation unit 111 when the pressing operation unit 111 receives the tilting operation.

The vector sensor 140 includes a thin diaphragm 143 arranged at the top surface, a strain gauge 141 attached to the lower surface of the diaphragm 143, and a protective resin 145 for protecting the strain gauge 141.

When the pressing operation unit 111 receives a tilting operation, the diaphragm 143 in the vector sensor 140 deforms because of the pressing force applied to the pressing operation unit 111, and the strain gauge 141 detects the strain of the diaphragm 143.

The operation of the vector sensor 140 will be described later. The vector sensor 140 corresponds to the vector sensor 14 of FIG. 1A. Reference character 142 in FIG. 4A indicates a spacer which fixes the vector sensor 140 at the position.

At the center of the vector sensor 140, a tube-like through hole 144 penetrating the vector sensor 140 from up to down is formed. In the through hole 144, the shaft 110 is arranged so as to penetrate the through hole 144.

The protective resin 145 for protecting the strain gauge 141 is arranged outside the outer circumferential surface of the through hole 144 so as not to obstruct the operation of the shaft 110 which slides up and down within the through hole 144. The shaft 110 corresponds to the shaft 11 of FIG. 1A.

The shaft 110 has a lower end in contact with the upper end of the sliding body 132 of the switch 130, and an upper end inserted into the through hole 144 and protruding from the upper end of the through hole 144 of the vector sensor 140. Outer circumferential surface of the shaft 110 is in contact with the inner circumferential surface of the through hole 144 at the middle portion of the shaft 110. The shaft 110 is configured so as not to affect the vector sensor 140 when sliding up and down.

The shaft 110 is configured to be slidable only in the up-down direction within the through hole 144. In other words, the shaft 110 is configured to be movable only in the axial direction. The shaft 110 is configured to be movable only in the axial direction in order to achieve both the downsizing of the operation unit 100 and the prevention of the erroneous control caused by the shaking of the vehicle or the like.

When the shaft 110 is allowed to tilt, the operation unit 100 has to be made larger by the amount the shaft 110 tilts. In addition, when the shaft 110 is allowed to tilt, if the vehicle on which the operation unit 100 is mounted shakes violently, the shaft 110 may tilt even though no operation is performed. Then, the in-vehicle device 300 may operate against the driver's will.

In the operation unit 100, the shaft 110 is configured to be movable only in the axial direction to realize both the downsizing of the operation unit 100 and the prevention of the erroneous control caused by the shaking of the vehicle or the like.

On the upper surface of the frame 103, an encoder plate 153 and a fixed contact 152 are arranged in a fixed manner. On the fixed contact 152, a movable contact 151 is arranged rotatable about the shaft 110 as the rotation axis. The fixed contact 152 and the movable contact 151 are disk-shaped member with a through hole in the center. The shaft 110 penetrates through this through hole.

In the operation unit 100, a rotation sensor 150, which detects the rotating state of the rotating operation unit 120, is configured with the encoder plate 153, the fixed contact 152 and the movable contact 151. The operation of the rotation sensor 150 will be described later. The rotation sensor 150 corresponds to the rotation sensor 15 of FIG. 1A.

The rotating operation unit 120 which rotates in conjunction with the movable contact 151 may be arranged on the movable contact 151. In FIG. 4A, the antislip member 121 arranged on the operation surface of the rotating operation unit 120 is not shown. Alternatively, a material whose surface has high sliding resistance, such as rubber, may be used; or, a groove may be formed on the operation surface.

The rotating operation unit 120 is also a disk-shaped member having a through hole in the center through which the shaft 110 penetrates. In particular, the rotating operation unit 120 is formed so that the diameter of the disk-shaped member demarcates the movable range of the thumb of the adult when the palm is in a fixed state. Thus, the driver can operate the rotating operation unit 120 only by moving the thumb while keeping the palm on the steering wheel 200. At the upper end of the shaft 110 protruding upward from the through hole of the rotating operation unit 120, the pressing operation unit 111 is arranged.

Described next is the operation of the switch 130, vector sensor 140 and rotation sensor 150 in the operation unit 100 configured as described above and the mechanical operation of the operation unit 100.

The switch 130 includes the sliding body 132 which moves up and down within a predetermined range in conjunction with the sliding movement of the shaft 110, and the spring 133 which applies a force to, i.e., biases the sliding body 132 upwards in the axial direction. Further, the switch 130 includes the arc-shaped movable contact 134 which deforms into a depressed shape pressed by a rod-like member in the sliding body 132 when the sliding body 132 moves down to the lowermost position, and the fixed contact 135 which is brought into contact with the movable contact 134 when the movable contact 134 deforms into a depressed shape.

The switch 130 outputs a signal indicating that the pressing operation unit 111 receives a pushing operation to a control unit 160 (see FIG. 5) described later when the sliding body 132 moves down to bring the movable contact 134 and the fixed contact 135 in contact with each other.

The vector sensor 140 includes the strain gauge 141 as mentioned earlier. The strain gauge 141 is a resistive element which causes strain by the pressing force applied from outside and changes the value of electric resistance according to the amount of generated strain.

Specifically, the strain gauge 141 outputs the voltage corresponding to the pressing force when the strain is caused by the pressing force while a predetermined voltage is applied. In the vector sensor 140, the strain gauge 141 is arranged on the lower surface of the diaphragm 143.

In the vector sensor 140, when the pressing operation unit 111 receives a tilting operation, the thin diaphragm 143 deforms because of the pressing force. The strain gauge 141 detects the strain caused thereby. The strain gauge 141 outputs a voltage corresponding to the magnitude and the direction of the pressing force applied to the pressing operation unit 111 as a signal to the control unit 160 mentioned later.

When the rotating operation unit 120 receives a rotating operation, the rotation sensor 150 outputs pulses of a number corresponding to the rotation angle of the rotating operation unit 120 as a signal indicating the rotation angle of the rotating operation unit 120 to the control unit 160 mentioned later.

More specifically, in the rotation sensor 150, two or more electrodes are arranged at equal intervals on the upper surface of the fixed contact 152 around the shaft 110, and an electrode is arranged on the lower surface of the movable contact 151. The electrode on the lower surface of the movable contact 151 is brought into contact with the electrode on the upper surface of the fixed contact when the movable contact 151 rotates.

When the rotating operation unit 120 receives a rotating operation, the fixed contact 152 outputs pulses at a timing when the electrode of the fixed contact 152 and the electrode on the movable contact 151 touch with each other. The pulses are output to the control unit 160 via the encoder plate 153. The control unit 160 determines how wide the rotation angle of the rotating operation unit 120 is based on the pulses input via the encoder plate 153.

The encoder plate 153 determines the direction of rotation of the rotating operation unit 120 based on the position of the electrode among the electrodes arranged on the upper surface of the fixed contact 152 that touches the electrode on the lower surface of the movable contact 151. Then the encoder plate 153 outputs the result of determination to the control unit 160 mentioned later. The control unit 160 determines the direction of rotation of the rotating operation unit 120 based on the result of determination on the direction of rotation input from the encoder plate 153.

Thus, in the operation unit 100, for the switch 130 to detect the pushing operation, the pressing operation unit 111 has to be pushed in by a predetermined length in the axial direction, and the sliding body 132 of the switch 130 has to be lowered down against the repulsive force of the spring 133 until the sliding body 132 reaches the lowermost position. Thus, the operation unit 100 can give the driver a clear sense of operation (feeling of click) by forcing the driver to perform the above operation at the time of pushing operation.

Thus, the operation unit 100 can prevent the driver from repeatedly performing the pushing operation on the pressing operation unit 111 in the axial direction after the operation unit 100 properly receives the pushing operation of the pressing operation unit 111 in the axial direction.

Further, the rotating operation unit 120 in the operation unit 100 is configured to rotate around the shaft 110 when the driver touches the rotating operation unit 120 by the thumb S while keeping the palm on the steering wheel 200 and slides the thumb S in a direction other than the axial direction of the shaft 110 within the movable range of the thumb S.

Thus, in the operation unit 100, while the driver is operating the rotating operation unit 120 by the thumb S, the thumb S moves along the rotating trajectory of the rotating operation unit 120. Thus, the operation unit 100 can prevent the driver from operating the pressing operation unit 111 by mistake while operating the rotating operation unit 120 by the thumb S, which is not suitable for a delicate manipulation.

In the operation unit 100, the switch 130 is arranged in contact with the lower end of the shaft 110, the vector sensor 140 is arranged above the switch 130, and the rotation sensor 150 is arranged above the vector sensor 140.

Hence, in the operation unit 100, the circumferential surface of the middle portion of the shaft 110 can be brought into contact with the vector sensor 140. Thus, in the operation unit 100, the distance between the pressing operation unit 111 which serves as a point of effort at the time of tilting operation and the diaphragm 143 of the vector sensor 140 which serves as a point of load can be made as long as possible, and the pressing force can be efficiently detected by the vector sensor 140.

An example of the functional configuration and the operation of the operation unit 100 will be described with reference to FIGS. 5, 6A-6C, 7A-70. FIG. 5 is a block diagram illustrating the functional configuration of the operation unit 100 according to the present embodiment.

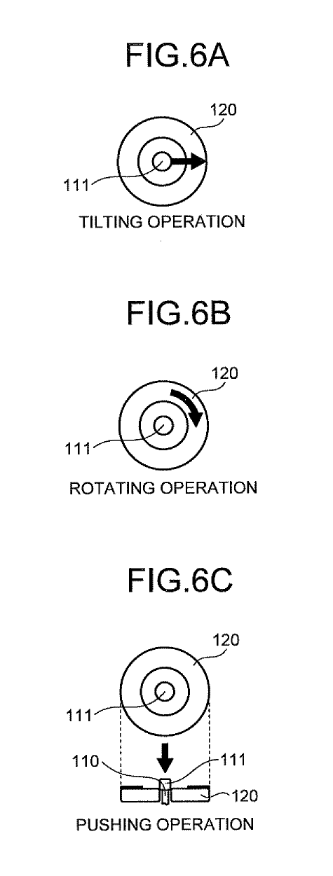

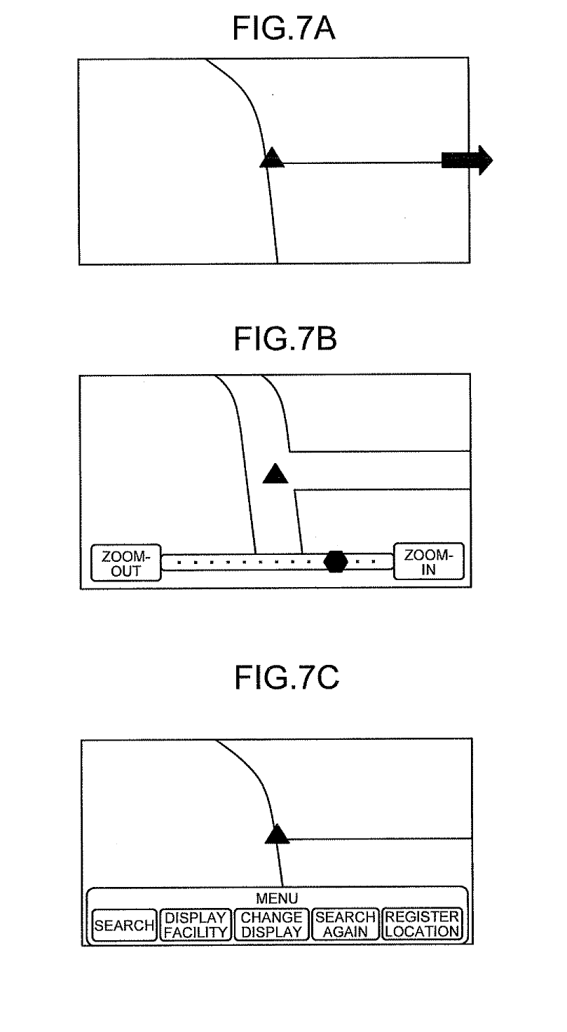

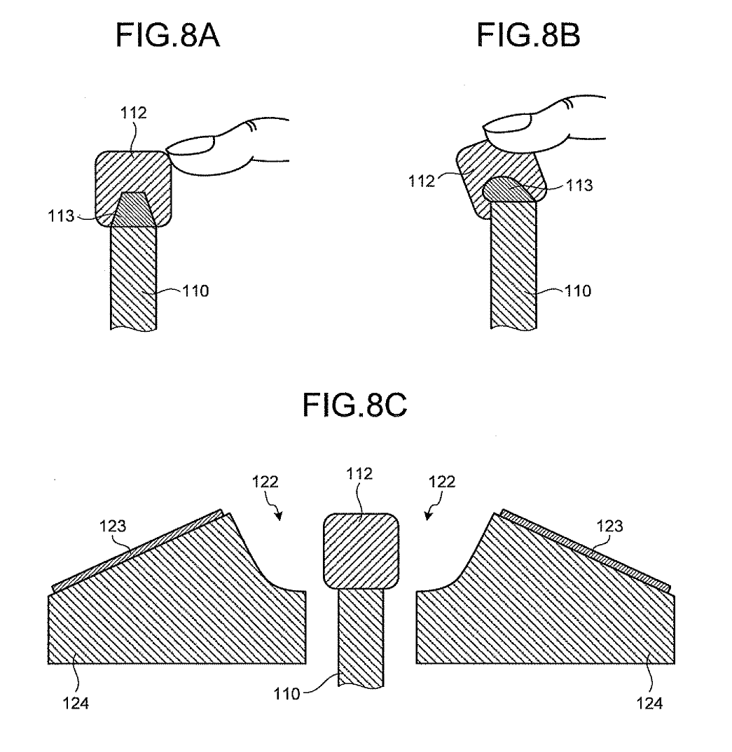

Further, FIGS. 6A to 6C are diagrams illustrating an example of operation of the operation unit 100 according to the present embodiment, and FIGS. 7A to 7G are diagrams illustrating an example of display corresponding to the operation of the operation unit 100 according to the present embodiment.

As illustrated in FIG. 5, the operation unit 100 includes the switch 130, the vector sensor 140, the rotation sensor 150 and the control unit 160. The operation unit 100 is connected to the in-vehicle device 300.

The switch 130, the vector sensor 140 and the rotation sensor 150 illustrated in FIG. 5 are the same as those illustrated in FIG. 4A. Hence their description will not be repeated. As illustrated in FIG. 5, the control unit 160 determines the operation state of the pressing operation unit 111 and the rotating operation unit 120 based on the signals supplied as inputs by the switch 130, the vector sensor 140 and the rotation sensor 150, and outputs a control signal corresponding to the result of determination to the in-vehicle device 300.

The control unit 160 includes a strain determining unit 161, a pulse counter 162 and an ON/OFF determining unit 163. The strain determining unit 161 determines the magnitude and the direction of the pressing force applied to the pressing operation unit 111 based on the signal supplied as an input by the vector sensor 140 when the pressing operation unit 111 receives the tilting operation.

Specifically, in the vector sensor 140, the diaphragm 143 deforms when the outer circumferential surface of the shaft 110 presses the inner circumferential surface of the through hole 144 as a result of tilting operation on the pressing operation unit 111.

Then, in the vector sensor 140, the strain gauge 141 detects the strain of the deformed diaphragm 143, and outputs a voltage corresponding to the detected strain, i.e., a voltage corresponding to the pressing force to the strain determining unit 161 as a signal.

Subsequently, the strain determining unit 161 converts the signal obtained from the vector sensor 140 into a two-dimensional vector. The strain determining unit 161 calculates a resultant vector of each vector to determine the magnitude and the direction of the pressing force applied to the pressing operation unit 111.

The strain determining unit 161 then outputs a control signal corresponding to the result of determination to the in-vehicle device 300, thereby causing the in-vehicle device 300 to execute the process corresponding to the tilting operation. For example, assume that the pressing operation unit 111 receives a tilting operation towards the right side by a predetermined pressing force as illustrated in FIG. 6A when the navigation device 301 is selected as the operation target of the operation unit 100.

Then, the strain determining unit 161 causes the navigation device 301 to execute a control operation to scroll the map image on the display to the right as illustrated in FIG. 7A. At this time, the strain determining unit 161 causes the map image on the display to scroll at a speed corresponding to the magnitude of the pressing force obtained as a result of determination.

Further, the pulse counter 162 determines the rotating state of the rotating operation unit 120 based on a signal supplied as an input from the rotation sensor 150 when the rotating operation unit 120 receives a rotating operation.

Specifically, the rotation sensor 150 outputs pulses of a number corresponding to the rotation angle of the rotating operation unit 120 to the pulse counter 162 when the rotating operation unit 120 receives a rotating operation. The rotation sensor 150 determines the direction of rotation of the rotating operation unit 120 based on the position of the electrode among the electrodes on the upper surface of the fixed contact 152 which touches the electrode on the lower surface of the movable contact 151, and outputs the result of determination to the pulse counter 162.

Then, the pulse counter 162 determines the direction and the angle of rotation of the rotating operation unit 120 based on the result of determination concerning the direction of rotation of the rotating operation unit 120 and the number of pulses supplied as an input by the rotation sensor 150.

Subsequently, the pulse counter 162 outputs the control signal corresponding to the result of determination to the in-vehicle device 300 to cause the in-vehicle device 300 execute the process corresponding to the rotating operation. For example, assume that the rotating operation unit 120 receives a rotating operation in a clockwise direction by a predetermined angle as illustrated in FIG. 6B when the navigation device 301 is selected as the operation target of the operation unit 100.

Then, the pulse counter 162 causes the navigation device 301 to execute the control operation to zoom in the map image on the display by a magnification factor corresponding to the rotation angle of the rotating operation unit 120 as illustrated in FIG. 7B. When the rotating operation unit 120 is determined to be rotated in a counterclockwise direction, the pulse counter 162 causes the navigation device 301 to execute the control operation to zoom out the image on the display.

Further, the ON/OFF determining unit 163 determines whether the pressing operation unit 111 receives a pushing operation or not based on a signal supplied as an input by the switch 130.

Specifically, in the switch 130, when the pressing operation unit 111 receives a pushing operation, the sliding body 132 slides downwards along with the sliding movement of the shaft 110 downwards in the axial direction. Then, the lower end of the sliding body 132 presses the movable contact 134 to deform the movable contact 134 into a depressed shape.

Thus, the movable contact 134 and the fixed contact 135 of the switch 130 are brought into contact with each other, and the switch 130 is turned into ON state. In the switch 130, when the pressing force in the axial direction to the pressing operation unit 111 is released, the sliding body 132 slides upwards because of the force applied by the spring 133. Then, in the switch 130, the movable contact 134 returns to the original shape and the movable contact 134 and the fixed contact 135 are separated from each other to turn the switch 130 into OFF state.

When the movable contact 134 and the fixed contact 135 are brought into contact with each other, the switch 130 outputs a signal indicating the ON state to the ON/OFF determining unit 163. The ON/OFF determining unit 163 determines that the pushing operation has been made when a signal indicating that the switch 130 turns into ON state is supplied as an input.

Then, on determining that the pushing operation has been made, the ON/OFF determining unit 163 outputs a control signal indicating that the pushing operation has been made to the in-vehicle device 300, and causes the in-vehicle device 300 to execute a control operation corresponding to the pushing operation. For example, assume that the pressing operation unit 111 receives a pushing operation as illustrated in FIG. 6C while the navigation device 301 is selected as the operation target of the operation unit 100.

Then, the ON/OFF determining unit 163 causes the navigation device 301 to execute the control operation to display menu image as illustrated in FIG. 7C. Thus, the operation unit 100 can realize various types of operations corresponding to the in-vehicle device 300 selected as the operation target through the manipulation only by the thumb, thereby improving the operability of the in-vehicle device 300.

Incidentally, in the operation unit 100, the shaft 110 is configured to be movable only in the axial direction in order to prevent the erroneous control caused by the shaking of the vehicle or the like and to downsize the operation unit 100 at the same time.

If changes are made to the configuration of the pressing operation unit 111 in the operation unit 100 of the above configuration, the feeling of tilting operation on the pressing operation unit 111 can be more clearly conveyed to the driver. In addition, with the changes in shape of the rotating operation unit 120, the erroneous operation of the operation unit 100 by the driver can be prevented more securely.

With reference to FIGS. 8A to 8C, modification of the pressing operation unit 111 and the rotating operation unit 120 will be described. FIGS. 8A to 8C are diagrams illustrating the modification of the pressing operation unit 111 and the rotating operation unit 120 of the operation unit 100 according to the present embodiment.

FIGS. 8A and 8B illustrate a vertical section passing through the center of a pressing operation unit 112 of the modification, and FIG. 8C illustrate a vertical section passing through the center of a rotating operation unit 124 of the modification.

As illustrated in FIG. 8A, the pressing operation unit 112 according to the modification has a depressed portion on a surface at the side attached to the shaft 110. When the pressing operation unit 112 is attached to the shaft 110, an elastic body 113 is arranged between the upper end of the shaft 110 and the pressing operation unit 112. The elastic body 113 has a predetermined elasticity and can be fitted into the depressed portion formed in the pressing operation unit 112.

With such configuration, when the pressing operation unit 112 receives a tilting operation as illustrated in FIG. 8B, though the shaft 110 does not move, the elastic body 113 deforms because of the pressing force generated by the tilting operation. Hence, the pressing operation unit 112 tilts in the direction of pressing force.

Thus, even when the shaft 110 is configured to be movable only in the axial direction, the operation unit 100 can clearly convey the feeling of operation to the driver when the pressing operation unit 112 receives a tilting operation.

Hence, the operation unit 100 can prevent the driver from repeatedly performing the tilting operation on the pressing operation unit 112 by mistake after the pressing operation unit 112 properly receives the tilting operation.

Further, as illustrated in FIG. 8C, the rotating operation unit 124 according to the present modification includes a depressed portion 122 in a predetermine area around the center of rotation on the operation surface. When providing the depressed portion 122, it is desirable that the depressed portion 122 be arranged within a movable range of the thumb S within which the thumb moves to perform the tilting operation on the pressing operation unit 112.

When the depressed portion 122 is arranged on the operation surface of the rotating operation unit 124, the operation unit 100 can prevent the driver from performing the erroneous operation on the rotating operation unit 124, for example, from touching the rotating operation unit 124 with the thumb by mistake while performing the tilting operation of the pressing operation unit 112 by the thumb.

Further, the depressed portion 122 also serves as an auxiliary groove which supports the operation of the pressing operation unit 112 because the driver can place the thumb in the depressed portion 122 while manipulating the pressing operation unit 112. Still further, when the pressing operation unit 112 is arranged in the depressed portion 122, the pressing operation unit 112 can be prevented from protruding out of the rotating operation unit 124. Thus, it is possible to prevent the driver from being hurt by the pressing operation unit 112 at the time of accident or the like.

Further, when the depressed portion 122 is arranged in the rotating operation unit 124, it is desirable that an antislip member 123 be arranged only in an area other than the depressed portion 122 in the upper surface of the rotating operation unit 124. With such configuration, even when the thumb touches the depressed portion 122 of the rotating operation unit 124 during the tilting operation of the pressing operation unit 112, the thumb easily slips on the depressed portion 122 because there is no antislip member 123 formed thereon. Hence, the rotation angle of the rotating operation unit 124 by the erroneous operation can be minimized.

Further, as illustrated in FIG. 8C, the operation surface of the rotating operation unit 124 may be configured so that it forms a downward slope from the top portion of the operation surface (outer edge of the depressed portion 122) towards the outer edge of the rotating operation unit 124 when viewed in the vertical section. With such configuration, the erroneous rotating operation can be prevented.

Specifically, with the above configuration, if the driver applies the pressing force on the shaft 110 by the thumb so as to press the thumb against the shaft 110 in the axial direction, during the rotating operation on the rotating operation unit 124, the thumb slips along the downward slope formed on the operation surface of the rotating operation unit 124 towards the outer circumferential side of the rotating operation unit 124.

Hence, even when the driver pushes hard the rotating operation unit 124 in the axial direction during the operation of the rotating operation unit 124, the thumb hardly moves toward the side of the pressing operation unit 112. Thus, the erroneous operation of the pressing operation unit 112 by the driver can be prevented.

Alternatively, the operation unit 100 may be configured such that the operation unit 100 is connected to other sensor mounted in the vehicle and determines the operation state of the pressing operation unit 111 and the rotating operation unit 120 based on the result of detection by the other sensor. The other sensor may detect any quantity concerning the operation of each unit in the vehicle.

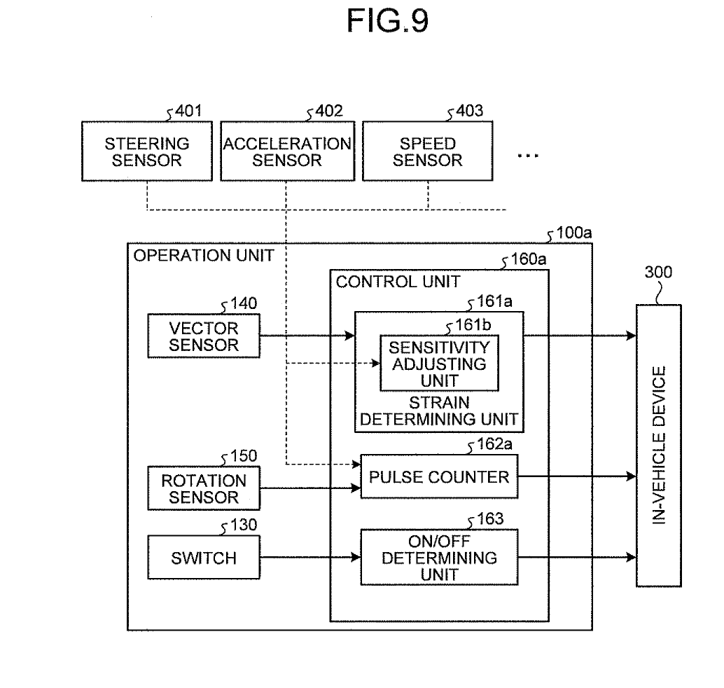

With reference to FIG. 9, an operation unit 100a which is connected to other sensors mounted in the vehicle is described. FIG. 9 is a block diagram illustrating the operation unit 100a connected to other sensors.

As illustrated in FIG. 9, the operation unit 100a is connected to a steering sensor 401 which detects the rotation angle of the steering wheel 200, an acceleration sensor 402 which detects the acceleration and vibration of the vehicle and a speed sensor 403 which detects the running speed of the vehicle.

The operation unit 100a illustrated in FIG. 9 is different from the operation unit 100 illustrated in FIG. 5 only in terms of operations by a strain determining unit 161a and a pulse counter 162a of a control unit 160a.

Specifically, the strain determining unit 161a illustrated in FIG. 9 includes a sensitivity adjusting unit 161b which virtually adjusts the sensitivity of the vector sensor 140 by correcting the signal supplied as an input from the vector sensor 140 based on a signal supplied as an input from each sensor arranged outside the operation unit 100a.

The sensitivity adjusting unit 161b virtually lowers the sensitivity of the vector sensor 140 when, for example, a signal indicating the shaking of the vehicle exceeding a predetermined value is input by the acceleration sensor 402. Thus, even when the driver performs the tilting operation on the pressing operation unit 111 by unnecessarily strong pressing force because of the shaking of the vehicle, the operation unit 100a would not reflect this tilting operation excessively on the control operation by the in-vehicle device 300.

Further, the pulse counter 162a stops counting the input pulses supplied from the rotation sensor 150 when a signal indicating that the steering wheel 200 rotates by an angle equal to or larger than a predetermined angle is supplied from the steering sensor 401, for example.

Thus, if the driver operates the rotating operation unit 120 with no intention when changing the hands on the steering wheel 200 to rotate the steering wheel 200 more than 360 degrees, for example, the operation unit 100a can invalidate such operation.

Further, in the operation unit 100a, the control unit 160a can stop the control when the speed sensor 403 inputs a signal indicating that the speed of the vehicle exceeds a predetermined speed. Thus, according to the operation unit 100a, the safety can be increased by prohibiting the operation of the operation unit 100a during the high-speed driving.

Respective constituent elements of respective units shown in the drawings do not necessarily have to be physically configured in the way as shown in these drawings. That is, the specific mode of distribution and integration of respective units is not limited to the shown ones, and all or a part of these units can be functionally or physically distributed or integrated in an arbitrary unit, according to various kinds of load and the status of use.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An operation unit comprising:
a shaft that receives by its one end a pressing force applied through a pressing operation by a finger/thumb;
a rotating body that rotates about the shaft according to an operation by the finger/thumb within a movable range of the finger/thumb;
a first sensor that detects a pressing force applied to the shaft in an axial direction of the shaft;
a second sensor that detects a pressing force applied to the shaft in a direction other than the axial direction of the shaft; and
a third sensor that detects a rotating state of the rotating body.

2. The operation unit according to claim 1, wherein
the first sensor is arranged at another end of the shaft which is opposite to the one end,
the third sensor is arranged to surround the shaft at a position closer to the one end of the shaft than the first sensor,
the second sensor is a vector sensor arranged in contact with the shaft at a position closer to the another end of the shaft than the third sensor, and detects a pressing force corresponding to an amount of strain of the second sensor caused by the pressing force applied to the shaft in the direction other than the axial direction.

3. The operation unit according to claim 1, further comprising
a biasing member that biases the shaft by a predetermined biasing force in a direction against a pressing force applied to the shaft in the axial direction of the shaft,
wherein the shaft slides in the direction of a pressing force when receiving the pressing force in the axial direction of the shaft, and the shaft slides in an opposite direction to the direction of the pressing force because of the biasing force of the biasing member when the pressing force is removed.

4. The operation unit according to claim 1, further comprising
an elastic body which is arranged at the one end of the shaft and has a predetermined elasticity, and
an operation portion which is arranged at the one end of the shaft via the elastic body and operated by a finger or a thumb,
wherein the elastic body deforms and the operation portion tilts when the operation portion receives a pressing force applied in a direction other than the axial direction.

5. The operation unit according to claim 1, wherein
an operation surface of the rotating body further includes a depressed portion within a predetermined area around the center of rotation of the rotating body.

6. The operation unit according to claim 5, wherein
the rotating body includes an antislip member that prevents the finger/thumb from slipping on the operation surface outside the area of the depressed portion during the operation.

7. The operation unit according to claim 1, wherein
the rotating body is configured to have a downward slope from a top portion of the operation surface to an outer edge of the operation surface.

8. The operation unit according to claim 1, wherein
the shaft and the rotating body are arranged at a predetermined position where a finger or a thumb of a driver driving a vehicle can reach.

9. The operation unit according to claim 8, wherein the predetermined position is a steering wheel of the vehicle.
